(19) United States
(12) Patent Application Publication
(10) Pub. No.: US 2010/0303358 A1
(43) Pub. Date: Dec. 2, 2010

(54) METHOD FOR THE AUTOMATIC ANALYSIS OF IMAGE DATA OF A STRUCTURE

(76) Inventor: Mausumi Acharyya, Bangalore (IN)

Correspondence Address: HARNESS, DICKEY & PIERCE, P.L.C., P.O.BOX 8910, RESTON, VA, 20195, US

(21) Appl. No.: 12/786,853

(22) Filed: May 25, 2010

(30) Foreign Application Priority Data
May 27, 2009 (DE) 10 2009 022 834.9

(51) Int. Cl. G06K 9/46; G06T 15/00

(52) U.S. Cl. 382/190; 345/419

(57) ABSTRACT

A method is described for the automatic analysis of image data of a structure. in at least one embodiment, the method includes: providing image data in the form of a three-dimensional voxel array, performing segmentation of the voxel array in order to determine a voxel subset, performing feature extraction at least for particular voxels of the voxel subset in order to generate a feature map, generating a scalar difference map on the basis of the feature map, performing classification with the aid of the difference map and identifying a structural anomaly in the image data on the basis of a classification result. A method for driving an image display device, an image processing system and an imaging system are furthermore described.

### PRIORITY STATEMENT

The present application hereby claims priority under 35 U.S.C. §119 on German patent application number DE 10 2009 022 834.9 filed May 27, 2009, the entire contents of which are hereby incorporated herein by reference.

### FIELD

At least one embodiment of the invention generally relates to a method for carrying out an automatic analysis of image data of a structure. At least one embodiment of the invention furthermore generally relates to an image processing system and/or to a computer program product for carrying out the steps according to at least one embodiment of the method.

### BACKGROUND

In modern diagnosis methods, computer tomography (CT) or magnetic resonance imaging (MRI) are often used in order to identify the causes of diseases, which cannot easily be recognized by other diagnostic methods. MRI is preferably used for imaging soft tissues such as internal organs, while CT is particularly suitable for imaging hard tissue, for example bone. In the known CT scan methods, the computer tomograph delivers for example a data stream or a signal, which represents different radiographic intensities (also referred to as “mass densities” or “attenuations”) in a region of the patient being examined. The signals are usually generated with the aid of an X-ray source rotating about a rotation axis of the patient, and a detector surface lying opposite the X-ray source. During the rotation, the X-ray source and the detector surface are driven sequentially or continuously along the rotation axis. From the signals, a series of cross-sectional image slices are then generated, or volume image data are generated in another way. A point or pixel of the image is then output according to the attenuation (conventionally expressed in the form of Hounsfield values) measured at the relevant point. The attenuations of the various tissues can be used in order to output any desired sectional images, for example in the form of gray-level images.

By using a CT or MRI method, it is thus possible to compile a three-dimensional array of voxels which can be automatically analyzed and used to output realistic three-dimensional representations (3D representations) for diagnostic purposes, for example 3D representation of the heart, the intestines, a bone etc. This makes these techniques on the one hand valuable not only for the analysis of soft tissues, but also for recognizing fractures which cannot be detected by conventional X-ray techniques, since these are restricted to recognizing fractures which show a clearly visible misalignment of the bone, such as a complete or compression fracture. X-ray images are generally unsuitable for recognizing weaker hairline or stress fractures.

Hairline fractures in bones of the body can occur for various reasons. Typically, hairline fractures are induced in weight-bearing bones, for example bones of the foot or leg, generally by repeated stressing, for example in sport, and they are therefore generally referred to as stress fractures. In contrast to this, hairline fractures in the bones of the skull or face usually occur owing to traumatic injuries. In a stress or hairline fracture, the fractured bone sections are not visibly misaligned.

Bone fracture identification with the aid of three-dimensional image data initially comprises a first “segmentation step”, in which possible bone regions are identified, and subsequent processing steps on the identified regions. According to the prior art, the segmentation is conventionally carried out by first performing a threshold value method (for example by comparing the available voxel values with a known estimated threshold value for bone, and rejecting all voxels with a value lower than this threshold value) and then a “refinement method”, for example a connectivity method and/or manual reprocessing. Segmentation of sizeable bones, for example weight-bearing bones, with the aid of a threshold value method normally provides acceptable results since the estimated Hounsfield values for bone are generally higher than those of the surrounding soft tissues, as well as being well known and essentially constant between different recordings.

Unfortunately, such discrimination based on a direct threshold value method is in practice not well-suited to all bone regions, in particular for thin bones not bearing weight, such as the bones inside the head. The recognition of hairline fractures in bones of the skull or face therefore remains difficult even when using CT or MRI technologies. The main reason for this is that the acquired signal is a digitally sampled signal with an inherent loss of information (compared with an analog signal). Furthermore, the noise in the images obtained makes it extremely difficult to recognize and subsequently visualize hairline fractures. Conventional techniques, such as edge detection or characterizing points of surface discontinuities, often fail. Particularly in the case of thin bones such as the bones of the face, the conventional technique for detecting points on surface discontinuities (typically based on edge detectors such as the Harris detector) does not work well owing to the pronounced intensity inhomogeneities and the noise in the CT images. Furthermore, a so-called “partial volume effect” can arise according to the threshold value method. This effect can occur when neighboring different tissue types—for example dense cartilage and thin compact bone—lead to the same attenuation value in a voxel. Since conventional segmentation methods are based only on gray-level value discrimination, the partial volume effect consequently leads to difficulties in finding thin bone structures. Another problem with threshold value methods is caused by artifacts, which can occur owing to abrupt transitions between tissues with high and low density even if the signal has been sampled finely enough. Furthermore, unknown local attenuations in the image must also be taken into account. Lastly, the high level of differences between bones of different subjects makes automatic analysis difficult.

### SUMMARY

In at least one embodiment of the invention, a device or method is provided for the reliable recognition of hairline fractures in three-dimensional image data, in particular CT image data.

In the method according to at least one embodiment of the invention for carrying out an automatic analysis of image data of a structure, image data are initially provided in the form of a three-dimensional voxel array and adaptive segmentation of the voxel array is performed, in order to determine a voxel subset. At least for particular voxels of the voxel subset, feature extraction is subsequently carried out in order to generate a feature map. This feature map is then used as a basis for generating a scalar difference map. Classification is then performed with the aid of the scalar difference map, and a structural anomaly in the image data is identified on the basis of a classification result.

If the image data are CT image data, the three-dimensional voxel array may for example be a three-dimensional matrix of Hounsfield gray-level values for the points in a three-dimensional region of interest of the patient being examined. Each point or voxel in the three-dimensional CT image can then be linked with a particular gray-level value according to the mass density or attenuation measured at this point.

The segmentation step may comprise the application of computer techniques, in order to identify regions of the three-dimensional CT image which correspond with the highest probability to bone, even if the bone is thin, for example a bone of the face.

The method according to at least one embodiment of the invention is consequently advantageous since computing time-intensive conduct of the feature analysis only needs to be carried out in the regions of the voxel array that contain specific relevant voxels, which correspond with the highest probability to bone.

The feature matrix obtained as a result better characterizes the bone voxels of the CT image in the form of features which are typical of the specific bone types, and therefore provides more powerful input data for the subsequent classification in which the voxels of the voxel array can be marked as healthy or fractured on the basis of their corresponding features. The method according to at least one embodiment of the invention thus offers an improved way of identifying fine anomalies in structures, such as hairline fractures in bone regions, and can therefore in particular assist in the diagnosis of fractures which were previously to be categorized as “difficult” since they generally cannot be identified by known processing techniques.

In a method according to at least one embodiment of the invention for controlling an image output device for the output of images of a structure, an image of the structure is derived from the three-dimensional image data of the structure and the trace of a structural anomaly, which has been identified with the aid of the above-described method for carrying out an automatic analysis of image data of a structure, is graphically superimposed on the image.

An image processing system according to at least one embodiment of the invention for the automatic analysis of image data of a structure comprises on the one hand an image data source for providing image data in the form of a three-dimensional voxel array. This image data source may be an apparatus such as a computer tomograph which delivers such data directly, or a memory in which the image data have previously been stored. The image processing system furthermore comprises an image analysis system, which is adapted so that segmentation of the voxel array is performed in order to determine a voxel subset, and feature extraction is performed at least for particular voxels of the voxel subset in order to generate a feature map, a scalar difference map is generated on the basis of the feature map, classification is performed with the aid of the difference map and a structural anomaly in the image data is identified on the basis of a classification result.

The steps of at least one embodiment of the method may be carried out with the aid of a computer program product which can be loaded directly into a memory of a programmable image analysis system for use in such an image processing system. The computer program product may have suitable program code segments for carrying out the steps of at least one embodiment of the method for the automatic analysis of the image data of a structure, when the program product is run on the image analysis system.

The dependent claims and the rest of the description respectively contain particularly advantageous refinements and configurations of the invention, and the image processing system may also be refined according to the dependent method claims.

As mentioned above, the method according to at least one embodiment of the invention may be applied to any suitable three-dimensional image data of structures, in order quite generally to find an anomaly in the structure. Without thereby restricting the invention in any way, however, it will be assumed below that the image data have been obtained in a CT imaging step and that the structure is a bone structure—in particular a thin bone structure. An example of a thin bone may be a bone of the face.

Since segmentation should ideally identify each voxel which belongs to a bone, preferably thin bone, the adaptive segmentation step in the method according to at least one embodiment of the invention preferably comprises analysis of the three-dimensional voxel array in order to obtain local structure orientation information, and then carrying out an adaptive threshold value method on the basis of the local structure orientation information. The term “adaptive threshold value method” is intended to mean that the voxels are not simply compared with an attenuation threshold value for bone. Rather, the characteristic of the local structure in the region of the voxel in question plays an important role in the decision whether a voxel belongs to a thin bone structure or to other tissue.

By using the local orientation or local structure information in the described manner, the number of sampling artifacts can be reduced significantly. By applying the above-described segmentation technique in the scope of the method according to at least one embodiment of the invention, errors such as partial volume artifacts can be avoided or at least significantly reduced, since the tensors contain information about the planarity or linearity in the neighborhood of a voxel and the isotropy thereof. It is therefore very much less likely that a “non-bone region” will be identified as a “bone region” or vice versa. By applying this technique, a voxel array is effectively resampled with a more accurate signal basis. By taking into account the characteristics, in particular of thin bone structures, the partial volume effect is thereby minimized and voxels which belong to bone are identified better.

After the segmentation has been performed, the result is provided as a data set that indicates which parts of the CT image correspond with the highest probability to bone, and which parts with the highest probability do not.

A feature extraction is a computationally demanding procedure. In a particularly preferred example embodiment of the invention, a bounding region (also referred to as a “bounding box” or “region of interest”) is therefore identified within the voxel array, and the feature extraction is performed only for particular voxels within the bounding region, preferably for all voxels within the bounding region and only for them. In this way, unnecessary computation outlay is advantageously reduced.

In a particularly preferred example embodiment of the invention, a multiplicity of different features (for each voxel within the bounding region) which optimally characterize a structure of the thin bone type are extracted during the feature extraction. In this case, different features may require that different numbers of voxels be taken into account. For example, one type of feature of a voxel may be extracted for the voxel in question while taking a neighboring voxel into account. In other words, in order to extract the feature for this voxel, it is also necessary for information of a neighboring voxel to be taken into account. Likewise, for another type of feature of this voxel, it may be necessary to take into account a plurality of voxels within a neighborhood of a particular size around this voxel. In another preferred example embodiment of the invention, for a particular feature, the voxel array or the bounding region is therefore subdivided into a multiplicity of three-dimensional array blocks and the feature extraction is performed specially on the voxels of these array blocks, the dimensions of the array blocks respectively being selected as a function of a feature type and/or a contour of the structure, for example the bone structure, in a region of the voxel array corresponding to the array block. On the “edges” of a bone structure, for example, the array blocks may be relatively small (for example a 2×2×2 array block) since any region outside the bone structure is not of interest, while the array blocks may be larger in “central” regions if this is necessary for the particular feature type. In order to improve the feature extraction further, an array block may also overlap a neighboring array block, so that as much information as possible is extracted from the voxels. The size of the overlap may in turn be determined by the structure contour, for example bone contour in this region and/or by the type of feature to be extracted. Variations in shape relating to different subjects (age, sex) can be compensated for better by these techniques.

As already mentioned in the introduction, the extent of the misalignment in a hairline or stress fracture may be so small that this type of fracture often cannot be seen in a visual inspection of X-ray or CT images. However, trabeculae (osseous rods) of a bone are aligned in special directions in order to support the forces acting on the bone as well as possible, and a fracture of the bone leads to a disturbance in this trabecular pattern in the region. In a preferred example embodiment of the invention, a feature extracted during the feature extraction therefore comprises a feature of a trabecular texture pattern, i.e. a feature which describes a pattern of the trabecular tissue. A multiplicity of features are preferably extracted, each of the features recording or describing some characteristics of the bone in relation to its trabecular nature. Such a feature of a trabecular texture pattern may, as explained in more detail below, be for example a fractal dimension feature, an intensity feature, an intensity gradient feature, a Gabor orientation map feature, a feature of a Markov network (Markov random field) etc.

The purpose of the feature extraction is to obtain a feature map for the voxels within the bone region of interest and to compare these data with data obtained previously for a comparable “healthy” bone region, so as to recognize any discrepancy which indicates whether a bone region to be examined is fractured or not. In a preferred example embodiment of the invention, the feature map therefore comprises a feature vector for each voxel of the three-dimensional voxel array, particularly preferably for each voxel within the bounding region. A feature vector may comprise one or more features for each voxel, for example a sequence of the aforementioned features of a trabecular texture pattern. A feature vector is preferably constructed in the same way, i.e. by using the same types of features, as an associated feature vector in a feature map which has been compiled from healthy training patterns, so that a 1:1 comparison is possible.

The data obtained previously for a comparable “healthy” bone region thus preferably also contain a feature map in which the feature vectors are constructed in the same way. An “average” feature map may be constructed by examining a comparable bone region for a number of subjects and averaging the results for each feature in each feature vector. Choice of the average feature map may depend substantially on the nature of the subject to be examined; for example, a selection may be made as a function of both bone type and age and/or sex. Naturally, as is clear to the person skilled in the art, the information content of such an average feature map increases with the number of subjects examined. Comparison of the feature map with an average feature map obtained previously preferably takes into account each voxel in the region of interest, that is to say each voxel is compared with its corresponding voxel within the average feature map in order to find any relevant difference. For this reason, in the method according to the invention, the scalar difference map is preferably obtained on the basis of the feature map in such a way that an entry for the scalar difference map is obtained by comparison of a feature vector of a feature map with an associated average feature vector determined previously.

In a comparison of the fractured bone with a healthy bone, the disturbance in the trabecular structure leads to a difference between the features of corresponding voxels in the image data and those in the average feature map. Here, it is clear that even “healthy” voxels within the image data may have features which differ slightly from the corresponding features of the average feature map. In a particularly preferred example embodiment of the invention, when obtaining the scalar difference map on the basis of the feature map, an entry for the scalar difference map is therefore rejected when it has a value less than a predetermined threshold value, so that the scalar difference map only has entries which are greater than or equal to the predetermined threshold value. Basically, an entry of zero or close to zero in the scalar difference map may be interpreted as meaning that the region of the bone represented by the corresponding voxel is healthy, i.e. not fractured, while entries which are nonzero or have a value greater than or equal to a predetermined threshold value can indicate that the bone region recorded by this voxel is actually fractured. Since the average feature map has been calculated over all healthy training patterns, an image of a healthy bone structure should give a feature map which is very similar to the average feature map. It is to be expected that the difference map of this image will predominately have low values. In an image of a fractured bone, on the other hand, the fracture should cause some disturbances of the trabecular pattern. At some positions, the associated feature map should therefore be very different from the average feature pattern, and it is therefore to be expected that the associated scalar difference map will exhibit some large values.

On the basis of the entries in the scalar difference map which are nonzero, the voxels within the CT image can be characterized as to whether they probably belong to a path of a hairline fracture or not. To this end, in the method according to at least one embodiment of the invention, classification is performed and the conduct of the classification preferably comprises the application of at least one classifier, i.e. a suitable pattern recognition tool, to the entries of the scalar difference map, a classifier classifying a voxel which is linked with an entry of a scalar difference map into a class of a group of classes which contains at least one anomaly (or “fractured”) class and one non-anomaly (“non-fractured”) class. An entry in the scalar difference map is linked with a voxel, and therefore also with a feature vector in the feature map. Sets or groups of feature vectors can therefore be selected on the basis of their associated scalar difference map entries, and for each of the feature vectors of each set or group of voxels one or more rules may be applied in order to perform the classification. The features may be selected by applying standard feature selection techniques which are known to the person skilled in the art, for example the Mahalanobis distance, the Fisher criterion etc. Such techniques are used to determine how discriminant a feature set is in the identification of different classes, in this case the two classes “anomaly” and “non-anomaly”. Any suitable feature selection technique may in this case be applied in order to identify a usable feature set.

For the classification in the scope of the method according to at least one embodiment of the invention, one or more rules are preferably applied from a group of rules comprising a maximum rule, a minimum rule, a product rule, a sum rule, a majority vote rule, as will be explained in more detail below. It is to be pointed out that this group of rules is not exhaustive and other suitable rules may also be applied. It should also be borne in mind that the group of classes which are used in the classification is not necessarily restricted to two classes, but may also comprise one or more classes if so required.

The result of the classification is that each voxel which is probably linked with a fracture is characterized or marked as such. Individual voxels which are classified as fractured are expediently ignored, but a chain or group of neighboring voxels which are all classified as fractures can reliably be interpreted as an indicator that there is actually a fracture in the region of the bone.

In a particularly preferred example embodiment of the method according to at least one embodiment of the invention, the trace of a structural anomaly is displayed graphically in an image, which is obtained from the three-dimensional image data. As a diagnostic aid, for example, a group of bone voxels which has been classified as possibly fractured, may be supplemented graphically with a contour or line in order to highlight the associated bone region assumed to the fractured. A radiologist or doctor may then study the image in order to make a diagnosis and establish further treatments which are required.

### BRIEF DESCRIPTION OF THE DRAWINGS

Other advantages and features of embodiments of the present invention may be found in the following detailed description in conjunction with the appended drawings. It is clear that the drawings are merely used for the purpose of illustration and not to define the limits of the invention.

FIG. 1 shows a flow chart of the steps of an example of a method according to an embodiment of the invention,

FIG. 2 shows a schematic representation of a feature map obtained by applying the method according to an embodiment of the invention, and

FIG. 3 shows a block diagram of an example embodiment of an image processing system according to the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

Owing to the large number of equations which are required in order to describe the method steps, the mathematical notations used in the following description of the figures are not necessarily entirely consistent. The person skilled in the art is, however, familiar with the equations and expressions used, as well as the way in which they should be interpreted.

Three-dimensional CT image data of a bone region will be used as an example below, and the method according to an embodiment of the invention will be used in order to recognize a fracture in the bone region.

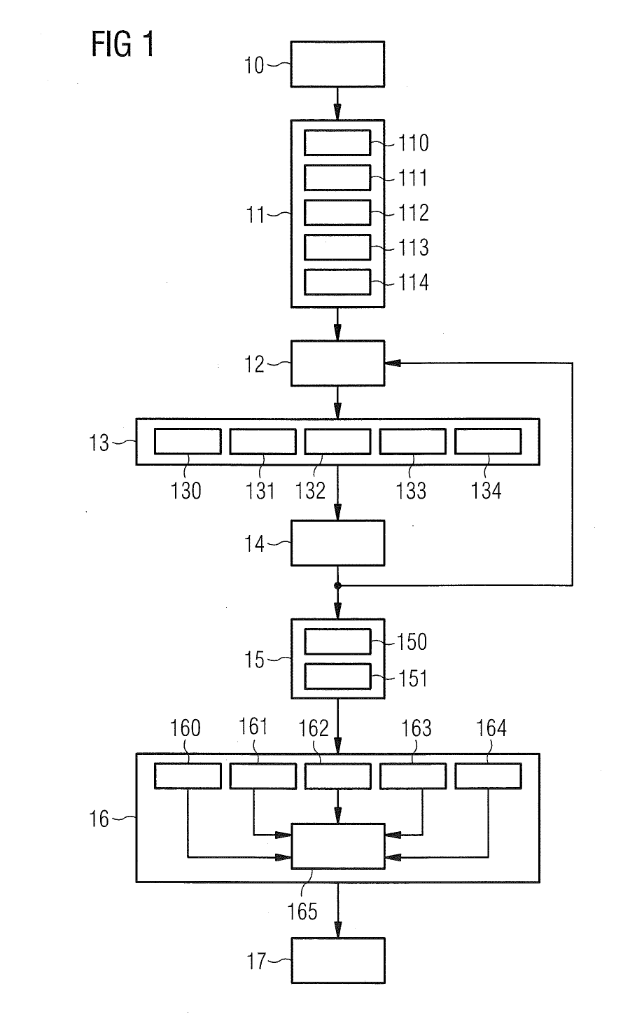

FIG. 1 shows a flow chart for the conduct of a hairline fracture analysis according to an example embodiment of the method according to the invention. In step 10, a CT data set is first obtained which comprises a number of “slices” of the object being examined. This data set may be regarded as a three-dimensional array of voxels, each voxel corresponding to a “point” in a three-dimensional image of the object and containing an attenuation value reconstructed for the corresponding point.

In step 11, three-dimensional segmentation is performed on the entire 3D voxel array in order to identify all voxels within the 3D image which correspond with the highest probability to bone. This segmentation step 11 comprises a number of method steps:

In step 110, a three-dimensional local orientation tensor Γ is calculated for each voxel by using quadrature filters, which tensor Γ describes the orientation of a local neighborhood and therefore acts as a feature descriptor for edges, lines or planes in this region. A representation of a three-dimensional local orientation tensor is in this case calculated using a combination of the output data of six polarly different quadrature filters. Each filter employs a log-normal quadrature filter Q which is spherically separable and has a Gaussian radial frequency function on a logarithmic scale:

Q(u)=R(ρ)Dₖ(û) (1.1)

Here, u is a multidimensional frequency variable and R(ρ) and Dₖ(û) are respectively the radial function and the direction function. The result of this filter is then used to obtain the three-dimensional local orientation tensor:

$$Γ = {\sum }_{k} {M}_{k} {q}_{k} \qquad ( 1.2 )$$

where qₖ is the output value of the k^{th} quadrature filter and Mₖ is a dual tensor basis corresponding to tensor basis

Xₖ=\hat{x}ₖ\hat{x}ₖ^{T} (1.3)

with \hat{x}ₖ as filter direction vectors.

Then, in step 111, the three eigenvalues λ₁, λ₂, λ₃ for the tensor Γ are calculated and sorted in decreasing order, so that λ₁≧λ₂≧λ₃≧0. On the basis of the ratios between the eigenvalues of the orientation tensor, it is possible to determine the “shape category” to which the neighborhood belongs. Assuming that the eigenvalues of the tensor Γ in Equation (1.2) above satisfy the condition

λ₁≧λ₂≧λ₃≧0, (1.4)

three neighborhood cases occur:

(i) planar: λ₁>>λ₂≈λ₃

(ii) linear: λ₁≈λ₂>>λ₃

(iii) spherical: λ₁≈λ₂≈λ₃

In step 112, a planarity measure O for the voxel is determined by using the ratio of λ₂ to λ₁. For the planar case, the following certainty estimate is used:

$$O = \frac{{λ}_{1} - {αλ}_{2}}{{λ}_{1}} for α > 1 \qquad ( 1.5 )$$

For a large value of α, all certainty estimate values for the non-planar case are close to zero.

Subsequently, in step 113, a threshold value T is calculated for a spatial position x and for a selected value O:

T(x)=T₀−βO(x) (1.6)

Here, T₀ is a global threshold value, β is a constant and O(x) is the planarity measure. A planarity measure is selected since thin bone structures are difficult to segment. Through adaptation of the threshold value by using a certainty estimate value O, thin bone structures can be found more readily. Since thin bones have such a planar structure, each voxel which has a high planarity measure defined by the certainty estimate value O is segmented out on the basis of the global threshold value, which is modified by the local structure information implicitly given by the value O.

In a final step 114, a voxel is characterized as representing a bone if Γ>T, otherwise it remains ignored. Overall, the segmentation step 11 serves to identify the parts of the 3D image, or voxels V, which with the highest probability are bone and which are therefore of interest for the purposes of the fracture identification. At least one relevant subset of these segmented image data may be obtained by a boundary region, and the subsequent feature extraction only needs to be performed on the voxels within this boundary region.

In the subsequent step 12, adaptive sampling is performed for each feature type in a loop which comprises a feature extraction step 13 and a feature map addition step 14.

The adaptive sampling essentially comprises a first subdivision of the results of the segmentation into smaller 3D blocks of voxels (also referred to as array blocks). Neighboring array blocks of voxels may overlap by a particular amount, in which case the amount of overlap, which may for example lie anywhere between 30% and 70%, may be determined during the method or beforehand on the basis of experimental training data. The size of each block is determined on the basis of the segmented bone region (for example, a block size may be selected on the basis of the bone contour) and as a function of the type of feature to be extracted in the subsequent step. The adaptive sampling step 12 is performed for each feature in the subsequent feature extraction step 13, so as to obtain 3D blocks with a size most suitable for the feature type in question.

In the feature extraction step 13, particular features are extracted for each voxel of the voxel array within the bounding region, in order to construct a feature map in the form of a matrix in which each row belongs to a voxel within the bounding region (and therefore to a point within the three-dimensional image) and each column belongs to a feature of this voxel, so that a full row of a completed feature map finally forms a feature vector for this voxel. In this exemplary embodiment of the method according to the invention, one of the following extractions is performed for each iteration of the feature extraction step:

(i) extraction of a feature of a fractal dimension;
(ii) extraction of a lacunarity feature;
(iii) extraction of a Gabor orientation feature;
(iv) extraction of a feature of a Markov network;
(v) extraction of an intensity gradient feature,
and in each iteration the feature vector for each voxel is expanded by corresponding values. It is clear that any other desired suitable features may also be extracted, and the features described here are merely examples. The feature extraction step 13 within the loop is performed until all desired features have been extracted:

In step 130, the fractal dimension is calculated for each 2D slice of each block. For each block with an edge length n, a feature of a fractal dimension is extracted for each n×n plane or slice. The feature map is then expanded in step 14 by the feature of the fractal dimension for each voxel in question.

For each 2D section of the CT image, a numerical estimate of the roughness of the trabecular texture is obtained by estimating the fractal dimension:

For a surface z=f (x, y) of a given value pair (i, j), the variation V_{ε} (i, j) is defined as the difference between the extreme values of f in an ε locality of (x, y):

V_{ε}(i,j)=max f(i,j)−min f(i,j) (2.1)

where max and min are calculated over a disk or circular region which is given by

(x−i)²+(y−j)²≦e². (2.2)

The variation Vf(ε) of f is the sum of V_{ε}(i, j) over the entire surface. This variation method estimates the Minkowski-Bouligand fractal dimension by three minus the slope of a line fit [ln ε, ln Vf (ε)] according to the method of least squares over a suitable range of ε.

The feature of the fractal dimension, obtained in this way for each voxel, is then entered into the feature map in step 14 and the process returns to step 12, in which the voxel arrays are calculated again for the next feature.

In step 131, lacunarity features are extracted which indicate a quantitative measure of the distribution and the size of the “holes” in the bone region in question. Lacunarity features for a voxel may be calculated for different orders of magnitude, so that a plurality of lacunarity features can be obtained for a voxel.

In order to obtain a lacunarity feature, a sliding window or block with a size (r×r×r) is superimposed on the image and moved over the image as a sampling window, in order to collect lacunarity data of the image at each position. For each sampling block, the “mass” M is determined by adding up the total number of active positions (corresponding to the “bone voxels” which give an indication of the bone density). For each block mass M, the density distribution [n(M,r)] which is possible for the special block size (r) is then calculated. Subsequently, the distribution function [Q(M,r)] of the probability is then calculated by dividing [n(M,r)] by the total number of blocks of the order of magnitude r.

The lacunarity Λ for the order of magnitude r is then given by the mean square deviation of the fluctuations of the mass distribution probabilities divided by the associated mean value squared, and is expressed by:

$${Λ}_{( r )} = \frac{{\sum }_{M} {M}^{2} * Q ( M , r )}{{[ {\sum }_{M} M * Q ( M , r ) ]}^{2}} \qquad ( 2.3 )$$

where the mean probability distribution function is given by the sum over M*Q(M,r) and the variance probability distribution function is given by the sum over M²*Q(M,r). For each dimension, the feature map is expanded by adding the calculated lacunarity feature to the feature vector for this voxel in step 14, before the method returns to step 12 in which the array blocks are calculated again for the next feature.

In step 132, the texture pattern of a voxel is then obtained by using Gabor orientation features. The feature map may then be expanded again in step 14 by the Gabor orientation features for each voxel.

To this end, a set of Gabor filters are applied to each block, or array block, in order to extract the orientation of the texture pattern given by the trabecular lines. Since the texture pattern of “porous” or trabecular bone is associated with a narrow band of frequencies, twelve orientation filters are used, beginning with 0° and increasing the orientation in intervals of 15°, so that these filters record the frequency content of the bone structure precisely. The dominant orientation of the texture is then identified by the orientation of the Gabor filter with the greatest response. The orientation vectors outside the boundary contour of the bone are set to the null vector 0. An orientation map is given by

M=[uᵢⱼₖ] (2.4)

where uᵢⱼₖ is an eigenvector which represents the orientation of the trabecular tissue at a grid point (i,j,k). The feature map is then expanded by adding the Gabor orientation feature to the feature vector for the respective voxel in step 14, before a return is made to step 12 in which the array blocks are calculated again for the next feature.

In step 133, the intensity of a voxel is described by a linear combination of the intensities of the neighboring voxels. The feature map is then expanded in step 14 for each voxel by a texture feature of a so-called Markov network.

A Markov-network or Markov-random-field (MRF) texture model describes the intensity of a pixel p as a linear combination of the intensities of the neighboring pixels q:

$$I ( p ) = {\sum }_{q ∈ R ( p )} ( θ ( p , q ) I ( p + q ) + ɛ ( q ) ) \qquad ( 2.5 )$$

where θ(p,q) are the model parameters and ε(q) represents a zero average value and constant variance noise. Intensity normalization is preferably carried out before extracting the MRF texture model features.

The model parameter θ(p, q) at the point p is then calculated by minimizing the error E:

$$E = {[ I ( p ) - {\sum }_{q ∈ R ( p )} ( θ ( p , q ) I ( p + q ) + ɛ ( q ) ) ]}^{2} \qquad ( 2.6 )$$

The model parameters θ(p,q), with p=(i, j, k), are then normalized to a unit vector uᵢⱼₖ, in order to form an MRF texture map according to

M_{MRF}=[uᵢⱼₖ]. (2.7)

Entries inside the bone structure are regarded as null vectors. The feature map is then expanded by adding the MRF intensity features to the feature vectors for the respective voxels in step 14, before returning to method step 12 in which the array blocks are calculated again for the next feature.

Finally, for each voxel, the intensity gradient features which give a measure of the bone density in this voxel are calculated in step 134. The feature map is then expanded for each voxel by an intensity gradient feature in step 14.

To this end, the images are normalized so that their average intensities and contrasts are similar. For a given region R(p) centered on the point p, a region is searched for a point q whose intensity difference dₘ is the greatest:

$${d}_{m} ( p ) = {max}_{{q}^{′} ∈ R ( p )} \vert I ( p ) - I ( {q}^{′} ) \vert \qquad ( 2.8 )$$

The intensity gradient direction g(p) is then calculated as a vector difference

$$g ( p ) = sgn ( I ( p ) - I ( q ) ) \frac{q - p}{{d}_{m} ( p )} , \qquad ( 2.9 )$$

where sgn( ) is the sign function. The direction of g is then defined so that it points from a region of higher intensity to a region of low intensity. The intensity gradient direction is then calculated at each position (i, j, k) within the bone contour, in order to obtain an intensity gradient direction map:

M_{IG}=[uᵢⱼₖ] (2.10)

In this case, the gradient direction is defined as null for each voxel which lies within the established bounding region but outside the bone contour. The feature map is then expanded for the respective voxel by adding the intensity gradient features to the feature vector in step 14.

After all desired feature types have been extracted in the loop consisting of steps 12, 13 and 14, the further processing can be continued by using the completed feature map.

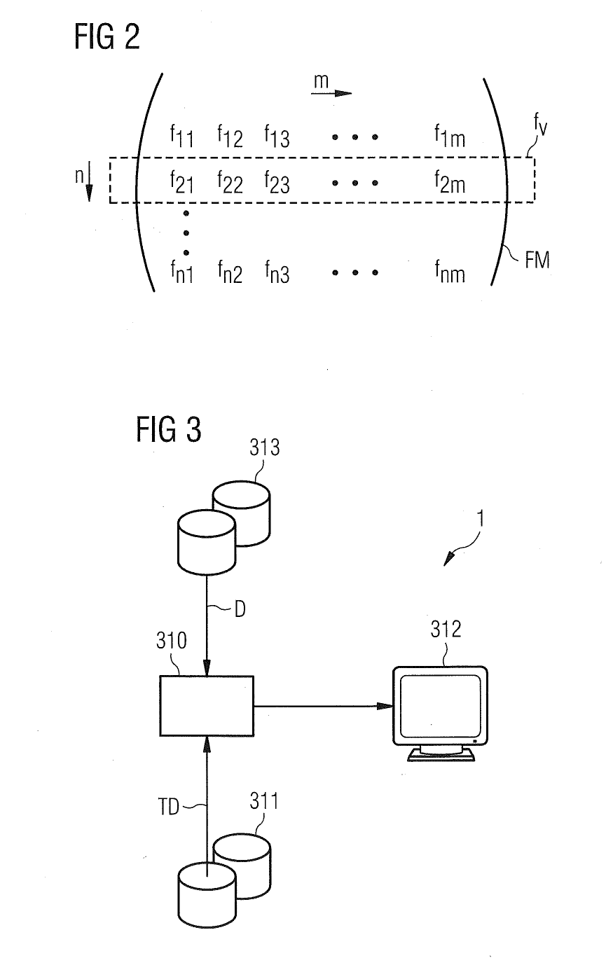

The feature map can then be represented as in FIG. 2, as a matrix which has as many rows n as the total number of voxels in the segmented CT image, while the number of columns m corresponds to the number of features which have been extracted for each voxel. A feature vector fv in this case corresponds to a voxel within the CT image, and is described by m features. In the example embodiment described above, the first feature f₂₁ of the feature vector fv corresponds for example to the fractal dimension of the voxel and the subsequent entries describe the lacunarity, measured for different orders of magnitude, followed by a number of Gabor orientation features (for example twelve such features, when twelve orientation Gabor filters are used). The penultimate feature is a Markov random field feature, and the last feature f₂ₘ corresponds to the intensity gradient of this voxel.

After the feature map has been completed, the analysis of the CT data can then be continued with this map in step 15. First, in step 150, the feature map is compared with an average feature map which is formed from various healthy training patterns M=[mᵢⱼₖ] for each feature type, which have been determined in a prior training method:

$${m}_{ijk} = \{ \begin{matrix}{\sum }_{s = 1}^{n} {u}_{s i j k} {‖ {\sum }_{s = 1}^{n} {u}_{s i j k} ‖}^{- 1} & if {c}_{i j k} > n / 2 \\ 0 & otherwise\end{matrix} \qquad ( 3.1 )$$

Here, mᵢⱼₖ is the average feature vector at the position (i, j, k) within the feature map M, n is the number of healthy training patterns, uₛᵢⱼₖ is the unit feature vector of a training example s at the position (i, j, k) and cᵢⱼₖ is the number of examples having feature vectors which are non-null at the position (i, j, k).

For a particular position (i, j, k), the associated value in the average feature map is set as a null vector and is regarded as insignificant if more than half of all the training example feature maps have a null value at this position. This situation usually arises near the boundary contour of a bone.

The feature map described above is a vector map, the format of which is not favorable for classification. Each feature map is therefore initially converted into a scalar difference map by comparing each entry in the feature map with the corresponding entry of the average feature map, in order to obtain the scalar difference map V=[vᵢⱼₖ]. Each entry vᵢⱼₖ in the scalar difference map is an indicator of the difference between a voxel at a position (i, j, k) in the feature map which has been obtained from the image data, and a corresponding voxel for the average feature map, and is given by:

$${v}_{i j k} = \{ \begin{matrix}0 & if {u}_{i j k} = {m}_{i j k} = 0 \\ 1 - \vert {u}_{i j k} \cdot {m}_{i j k} \vert & otherwise\end{matrix} \qquad ( 3.2 )$$

The entries in this scalar difference map lie between 0 and 1. A large value vᵢⱼₖ indicates a large difference, while a value vᵢⱼₖ which lies close to zero indicates a small difference. Values close to zero, all values below a predefined threshold, can consequently be ignored.

A significant value, which is nonzero, indicates that a difference has been detected for this voxel and that this voxel could therefore be assigned to a fracture in the bone region. Since the feature map was generated over all healthy training patterns, a healthy bone should lead to a feature map which is relatively similar to the average feature map. It is therefore to be assumed that the difference map for such an image mostly has small values. In an image of a fractured bone, on the other hand, some disturbances due to the fracture occur in the trabecular pattern. The associated feature map will therefore be very different from the average feature map at some positions, and it is to be expected that the scalar difference map will exhibit some large values.

This scalar difference map is then used as a basis for the subsequent classification step 16, in which regions of the bone are classified as “fractured” or “healthy”. To this end, in steps 160, 161, 162, 163, 164, one or more different classifiers are applied to the feature vectors having the nonzero scalar entries in the difference map, in order to determine the a posteriori probability that a voxel belongs to a healthy bone section or a fractured bone section.

The results of the classifiers are then combined in step 165, and each voxel is suitably characterized or correspondingly classified as belonging to the class “fractured” or to the class “non-fractured” (healthy).

Each classifier in this case measures the a posteriori probability P(ωⱼ|xᵢ) that a “sample” or “pattern” Z belongs to a particular class ωⱼ when using a selected set of feature vectors xᵢ. In other words, each classifier represents the given pattern by a vector measure, in this case the probability, that a pattern belongs to the class “healthy” order the class “fractured”. The sample or pattern Z essentially contains the voxel set which was used for calculating the feature vectors.

In the example embodiment of the method as described here, the following rules are used in the classification step, N denoting the number of classifiers, P(ωⱼ) being the associated vector measure and P(ωⱼ|xᵢ) being the a posteriori probability that the pattern in question belongs to a particular class:

Maximum rule: assign Z→ωₖ, if

$$k = arg {max}_{j} [ ( 1 - N ) P ( {ω}_{j} ) + N {max}_{i} P ( {ω}_{j} \vert {x}_{i} ) ] \qquad ( 4.1 )$$

Minimum rule: assign Z→ωₖ, if

$$k = arg {max}_{j} [ {P}^{- ( N - 1 )} ( {ω}_{j} ) {min}_{i} P ( {ω}_{j} \vert {x}_{i} ) ] \qquad ( 4.2 )$$

Product rule: assign Z→ωₖ, if

$$k = arg {max}_{j} [ {P}^{- ( N - 1 )} ( {ω}_{j} ) {\prod }_{i} P ( {ω}_{j} \vert {x}_{i} ) ] \qquad ( 4.3 )$$

Sum rule: assign Z→ωₖ, if

$$k = arg {max}_{j} [ ( 1 - N ) P ( {ω}_{j} ) + {\sum }_{i} P ( {ω}_{j} \vert {x}_{i} ) ] \qquad ( 4.4 )$$

Majority vote rule: assign Z→ωₖ, if

$$k = arg {max}_{j} {\sum }_{i} {Δ}_{j i} \\ where {Δ}_{j i} = \{ \begin{matrix}1 & if j = arg {max P ( {ω}_{l} \vert {x}_{i} )}_{i} \\ 0 & otherwise\end{matrix} \qquad ( 4.5 )$$

A bone is classified as fractured if a predetermined number of the classifiers classify a pattern as fractured. In the maximum rule, for example, a pattern (or a group of voxels) is assigned to a class which has the highest probability among the probabilities belonging to the pattern.

In a subsequent display step 17, a path of a probable hairline fracture is represented graphically with the voxels of one or more of the CT slice images, so that the fracture can be visually assessed for diagnostic purposes. This output may take place in a two-dimensional fashion, for example as a colored line which follows the calculated path of the fracture over a 2D image that has been reconstructed from the 3D image data, or alternatively in a three-dimensional fashion, in which case the path of the fracture can be observed with greater accuracy, for example on a computer screen.

FIG. 3 shows a block diagram of an image processing system 1. In this exemplary embodiment, three-dimensional image data D of a bone region, which were previously generated by using for example a computer tomograph and stored in a memory 313, are transferred to an image analysis system 310. The image data D are then processed by using the method steps described above with the aid of FIGS. 1 and 2, in order to obtain a feature map of voxels of the image data D, which is then examined in relation to known healthy data in order to locate possible fractures in the bone. An average value feature map is formed from training data TD, which have in turn been taken from a suitable data source such as for example a memory 311 having a database of known healthy subjects. If for example the three-dimensional image data have been taken from a temporal bone, the averaged feature map may be calculated by using training data TD which have been made from images of temporal bones of healthy individuals. Each discrepancy between the data sets D, TD is marked or characterized for a subsequent output step. A corresponding subset of voxels of the three-dimensional image data, which comprise the suspected fracture, as well as the information concerning which voxels need to be highlighted within the subset, are then transmitted to an image output means 312 so that the suspected fracture can be viewed by a diagnostician, for example a doctor or radiologist, in order to check the information and make a corresponding diagnosis.

Lastly, it should again be pointed out that the method described in detail above and the system architecture are merely preferred example embodiments, which may be modified in a wide variety of ways by the person skilled in the art without departing from the scope of the invention, as it is specified by the claims. For example, embodiments of the invention is not limited to the recognition of fractures in bones but may also be used for other material, for example porous material, which can be scanned in order to obtain three-dimensional image data and analyzed according to the described technique, in order to detect a structural anomaly in the material.

For the sake of clarity, it should also be pointed out that the use of the indefinite article “a” or “an” within this application does not preclude the possibility that there may be several of the relevant features, and that the term-“comprising” does not exclude further steps or elements.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for the automatic analysis of image data of a structure, comprising:
providing image data in the form of a three-dimensional voxel array;
performing segmentation of the voxel array to determine a voxel subset;
performing feature extraction at least for particular voxels of the voxel subset to generate a feature map;
generating a scalar difference map on the basis of the feature map;
performing classification with the aid of the scalar difference map; and
identifying a structural anomaly in the image data on the basis of a classification result.

2. The method as claimed in claim 1, wherein the performing of the segmentation comprises:
analyzing the three-dimensional voxel array to obtain local structure orientation information; and
carrying out an adaptive threshold value method on the basis of the local structure orientation information.

3. The method as claimed in claim 1, wherein a bounding region is established within the voxel array, and the feature extraction is performed for particular voxels of the bounding region.

4. The method as claimed in claim 3, wherein the voxel array or the bounding region is subdivided into a multiplicity of three-dimensional array blocks, and wherein the feature extraction is performed for the voxels in an array block, the dimensions of the array blocks being selected as a function of a feature type and/or a contour of the structure in a region of the voxel array corresponding to the array block.

5. The method as claimed in claim 1, wherein a feature extracted during the feature extraction comprises a feature of a trabecular texture pattern.

6. The method as claimed in claim 5, wherein the feature of a trabecular texture pattern comprises one of the following features:
a fractal dimension,
a lacunarity measure,
a Gabor orientation,
a Markov network, or
an intensity gradient.

7. The method as claimed in claim 1, wherein the feature map comprises a feature vector for each voxel of the voxel subset of the three-dimensional voxel array.

8. The method as claimed in claim 7, wherein the generation of a scalar difference map on the basis of the processing of the feature map comprises a comparison of a feature vector of the feature map with a previously determined corresponding averaged feature vector in order to obtain an entry for the scalar difference map.

9. The method as claimed in claim 8, wherein the generation of a scalar difference map on the basis of the processing of the feature map comprises the rejection of an entry for the scalar difference map when it has a value less than a predetermined threshold value.

10. The method as claimed in claim 8, wherein the conduct of the classification comprises at least the application of a classifier to entries of the scalar difference map, a classifier classifying a voxel which is linked with an entry of the scalar difference map into a class of a group of classes which contains at least one anomaly class and one non-anomaly class.

11. The method as claimed in claim 10, wherein one or more rules from a group of rules comprising
a maximum rule,
a minimum rule,
a product rule,
a sum rule,
a majority vote rule,
are applied within the classification.

12. The method as claimed in claim 11, wherein voxels of the voxel array which have been classified into the anomaly class during the classification are used for the visual representation of a structural anomaly in an image.

13. A method for driving an image display device for displaying a structural anomaly in an image of the structure, the image being obtained from three-dimensional image data of the structure and the structural anomaly being identified by way of a method as claimed in claim 1 and graphically represented in the image.

14. An image processing system for the automatic analysis of image data of a structure, the system comprising:
an image data source to provide image data in the form of a three-dimensional voxel array; and
an image analysis system, adapted to carry out at least the following:
performing segmentation of the voxel array to determine a voxel subset,
performing feature extraction at least for particular voxels of the voxel subset to generate a feature map,
generating a scalar difference map on the basis of the feature map,
performing classification with the aid of the scalar difference map and
identifying a structural anomaly in the image data on the basis of a classification result.

15. A computer program product which can be loaded directly into a memory of a programmable image analysis system for an image processing system, including program code segments for carrying out the method as claimed in claim 1 when the program product is run on the image analysis system.

16. The method as claimed in claim 2, wherein a bounding region is established within the voxel array, and the feature extraction is performed for particular voxels of the bounding region.

17. The method as claimed in claim 9, wherein the conduct of the classification comprises at least the application of a classifier to entries of the scalar difference map, a classifier classifying a voxel which is linked with an entry of the scalar difference map into a class of a group of classes which contains at least one anomaly class and one non-anomaly class.

18. The method as claimed in claim 17, wherein one or more rules from a group of rules comprising
a maximum rule,
a minimum rule,
a product rule,
a sum rule,
a majority vote rule,
are applied within the classification.

19. The method as claimed in claim 10, wherein voxels of the voxel array which have been classified into the anomaly class during the classification are used for the visual representation of a structural anomaly in an image.

20. A computer readable medium including program segments for, when executed on a computer device, causing the computer device to implement the method of claim 13.
